(19) United States
(12) Patent Application Publication
(10) Pub. No.: US 2015/0213691 A1
(43) Pub. Date: Jul. 30, 2015

(54) CONTROLLED TIMING OF VIDEO GAMING SOUND LEVELS

(71) Applicant: Brooke DUNN, Henderson, NV (US)

(72) Inventor: Brooke DUNN, Henderson, NV (US)

(21) Appl. No.: 14/168,010

(22) Filed: Jan. 30, 2014

(51) Int. Cl. G07F 17/34; G07F 17/32

(52) U.S. Cl. CPC G07F 17/34; G07F 17/3213

(57) ABSTRACT

A method and apparatus for controlling levels of sound volume emitted by a gaming apparatus may include a housing, a display system, a wager entering system, a CPU comprising a timing function and/or sound sensing system and a sound output system, wherein the CPU has software and/or hardware that provides distinctly different audio levels in a process. The method may be practiced by:
b) programming associated with the timing function automatically alters the level of sound by:
   i) lowering volume according to expected times of low local noise levels and increasing volume according to expected times of high local noise levels; and
   ii) sensing an extended period of low local sound volume so that emitted game volume is lowered or kept at a relatively low volume or sensing a high level of local sound volume so that emitted game volume is maintained at a relatively high level or raised to a relatively high level.

### BACKGROUND OF THE INVENTION

1. Field of the Invention

The present technology is directed towards the field of video slot gaming and the control of general sound levels in the system according to time of day and/or sensed changes in local sound levels within the gaming environment.

2. Background of the Art

In the original mechanical machines the reels were stopped by actuating a brake or a tripping arm/pin which moved into grooves (cutouts) in each reel's index wheel on a random timing basis. This method was carried over to the electromechanical machines of the 1960's as the basic stopping of the reels was by timewise releasing an index pin into grooves in index wheels attached to the reels with indicia displaying the game result. These varying depth grooves enabled, via physical contact closures of wipers being a part of the index arm mechanism and physical wiring to relay logic, payouts in accordance with the designed payout schedule which again was directly related to the probability of occurrence of the indicia—symbol—displayed on the reel itself. Such machines are directly susceptible to wear and tear (including erroneous electrical paths due to dirt and coin dust in particular, in the wiper contact area) as well as intentional tampering by both the player and unethical operators and their employees in violation of the regulations required for randomly probabilistic payoff.

Now electromechanical gaming devices are employed with a plurality of reels rotatable about a common axis and set into rotation by the pulling of a lever, by depressing a button, or automatically when the maximum amount for wagers has been wagered. However, even in these relatively newer devices, an electronic random number generator of some type is energized which generates one number corresponding to each of the various positions at which the reels can be stopped. As the game is played, each reel is stopped in sequence with the other reels at a position corresponding to each subsequent number generated. The angular rotational positions of the reels are detected at all times and the brake is engaged when the reel position corresponds to the random number generated for that reel. The probability for paying off on a combination of indicia on presently used machines, as described above, is dependent on the number of reels, the number of different angular rotational positions at which the reels can be stopped, and the number of winning combinations of indicia. In other words, the lowest probability for payoff that can be offered on presently used machines are 1 to N.sup.R where N is the number of angular rotational positions on each reel and R is the number of reels. Thus, for a three reel machine having 20 stop or index positions on each reel, the lowest probability that can be offered is 1:20.sup.3 or 1:8000. For a machine to be commercially viable, there is a limit on the largest amount that will be paid for any such single indicia combination.

The above reasoning explains why the slot machines which offer greatly increased payoffs are usually very large machines in terms of the number of reels and stop positions. The large machine provides the physical size to allow an increase in the number of reel stop positions as well as number of reels to increase the probability against payoff on any one position.

Video gaming is a form of entertainment involving the display of the format of a game on a video screen (presently on a cathode ray tube or monitor, liquid crystal display screen or any other visually observable image presenting system) and the interaction of a player(s) with data flow displayed on a screen. The player(s) may place wagers on the outcome of various statistically driven games which are displayed on the screen. Originally, the mechanical forerunners of video games were primarily limited to games having symbols displayed on reels, each symbol occupying a frame on the wheel, and the wheels being spun and then stopped to display a line of symbols (usually three symbols in a single row). Payouts were provided for certain specific symbol combinations on the payout line. Certain symbols became traditional on mechanical gaming machines (e.g., slot machines) such as the number “7,” cherries, bells, oranges, lemons, plums, etc. Over time, less traditional symbols were added to give the game a different visual appearance, but the play of the reel oriented slot machine game remained essentially the same.

Slot machines are gaming devices which originally incorporated a plurality of reels rotatable about a common axis and on which are carried at the periphery a plurality of indicia indicating the position each reel stops. Usually the reels are set into motion by pulling a lever and upon stopping, the angular positions of the reels are detected to determine the amount of payoff to the player. With physical reels, buttons may now be used to initiate and stop spinning of the reels to reduce stress on the arms of players. The gaming devices can also be programmed to automatically spin upon placing a wager, and automatically stop, without the player having to manipulate player controls.

It should be noted that the market demands higher and higher payoffs to maintain and increase player appeal, yet the casino or operator must be assured that the probability of win and payout allows for a reasonable business profit. Generally the profit-hold objectives before taxes and operational costs that are deducted are in the range as low as 2.7% and generally up to 15%. Hence, the higher payoff for a winning indicia combination must be counterbalanced with a lower probability for the high win combination of indicia. The introduction of video slot machines and CPUs has enabled the use of random number generators in combination with the virtual reels used, as in U.S. Pat. No. 4,448,419. The full capacity of CPUs have not yet been used in the play of video wagering games or in combination with physical reel slot machines. The term “physical reel slot machine” denotes the use of an actual physical reel with symbols, characters, or alphanumerics associated with the play of a wagering game.

Reel slot games or virtual reel slot games are provided with enhanced playing features by the use of novel formatting or display aspects on the reels or screen and sound system of the wagering apparatus. One aspect of visual enhancement of reels or virtual reels is the use of a border on the reels or virtual reels that simulates a thematic border around each frame or the majority of frames, particularly a border that emulates or duplicates the appearance of motion picture framing. An enhanced visual appearance is provided to each or certain frames in a reel or virtual reel by the use of a border on frames that has the appearance of the black edging (e.g., with sprocket holes, black sides, black spacing between frames, pictures in the frames, etc.). By providing frames with defined characters or symbols in the frames for winning outcomes, thematic changes may be made in the wagering apparatus by merely altering the specific thematic characters or symbols in the frames without the need of reprogramming the complete reel probabilities, appearance or the game. For example, a three reel (or three virtual reel) slot machine wagering game may be provided with a thematic format of the Three Stooges (with combinations of Curly, Larry, Moe, and Shemp), and the format may be changed to the Marx Brothers (with combinations of Chico, Harpo, Groucho, and Zeppo) simply by replacing the images in the frames, along with other optional modifications of the imagery or audio displays associated with the game. Special sound effects may be provided with the feeding of different denominations of currency or wagers into the machine or the wagering of different values of individual game wagers, with different sounds for the feeding currency or the wagering of 1, 2, 3, 4 and 5 or more coins, tokens or units.

When video gaming was first introduced to the gaming world, the first video games were electronic imitations of the traditional slot machines, even using the same symbols, and the same physical formats (e.g., a handle to initiate play), assuring that the transition from mechanical to electronic formats would meet the least resistance. As electronic gaming became more accepted, both the formats (e.g., buttons versus handles) and the game content (e.g., poker games, dominoes, keno, blackjack, Bingo, Pai Gow poker, etc.) were changed and expanded. The format of play within the electronic or virtual reel games has also progressed from the early duplications of the mechanical reels on a visual screen. The flexibility afforded the games by the use of computers, printed circuit boards, virtual images, and the high information density and volumes that can be used with electronic media, has enabled essentially unlimited formatting and image capability in the equipment. However, even with this potential, very little has been done with virtual reel games. The most notable product introductions in the virtual reel industry have included multiple payout lines on the displayed reels (e.g., payouts allowed on three rows when three tokens are played), multiple payout formats (e.g., payouts in rows, columns, diagonals, and/or patterns), and the imagery of the frames (e.g., different symbols, different themes for the symbols, and even animated movement within the frames of the symbols).

The various changes that have been and may be made in the virtual reel video systems may be characterized within three types of change classes: 1) changes that affect the probability of the awards; 2) changes that affect the fundamental nature of the game; and 3) changes that provide an entertainment or aesthetic variation to the game. Examples of changes that would affect the probability of awards would include, for example, selecting the total number of symbols within any reel or reels, selecting the number of any specific symbol within a reel or reels, selecting the number of lines or patterns for which there will be payouts, and the like. Examples of changes that would affect the fundamental nature of the game include, for example, the ability to retain a symbol on one or more reels from a first play and then re-spin remaining reel(s), the ability of a machine or player to ‘nudge’ a frame within one reel to a more favorable position, and the like. Examples of changes that would provide an entertainment or aesthetic variation to the game would include, for example, variations in artwork in the frames, variations in themes in the frames or in the background of the frames, and the like. Some of the more striking artwork renditions now include, for example, animation, such as faces on the symbols which alter their orientation (e.g., turn within the frame and look at another character), alter their expression (e.g., smile or frown or laugh), or otherwise provide a different image within the frame.

In a majority of video gaming devices, however, the imagery generally is still provided by reels (virtual or actual) that give the appearance of rotating in place, with the reels providing for entire columns, entire rows, or individual frames. It is always desirable within an entertainment field, such as video gaming, to be able to provide variations in the play and appearance of games to attract and maintain players.

The apparatus used for mechanical reel gaming normally comprises: a reel mounted for rotation about an axis through a predetermined number of radial positions; a motivation system to start rotation of said reel about said axis; indicia fixed to the reel to indicate the angular rotational position of the reel; various angular rotational positions of said reel having assigned thereto symbols, characters, or alphanumerics. There is usually a plurality of such said plurality of symbols exceeding said predetermined number of radial positions such that some rotational positions are represented by a plurality of symbols, characters, or alphanumerics assigned to each reel and even to each position on a virtual reel of the apparatus; the apparatus randomly selects one of the plurality of assigned symbols, characters, or alphanumerics; and the apparatus stops the reel at the angular position represented by a selected symbol(s), character(s), or alphanumeric(s).

U.S. Pat. No. 4,573,681 describes a slot machine is provided which has a winning probability table for storing a relation between a group of symbols and random numbers, the group being one of a plurality of groups made up by classifying prize-winning symbols. The patent also describes the use of “A sound generator 55 drives a loudspeaker 56 to generate a sound therefrom after a suitable time lapse from the start of a game, so that playing the game becomes more interesting.”

U.S. Pat. No. 6,656,046 (Yoseloff) describes a reel slot casino wagering apparatus comprises a housing having at least three displayed reels thereon, each reel having symbols, characters or alphanumerics that are displayed, a wager entering system, a CPU and a sound system. The CPU has software and/or hardware that provides distinctly different audio signals for at least one of 1) availability of the apparatus to start a new wagering game, 2) presence of bet credits, 3) amount of bet credits available, 4) number or amount of bet credits wagered or coins or token wagered, 5) revelation of a non-payout configuration, 6) position of only particular symbols where the total configuration of all symbols does not provide a payout, 7) size of a payout inclusive of payouts for non-jackpot awards, 8) denomination of currency or credits deposited, and 9) denoting one or more game losses.

There is also a desire in the industry to enable usage of gaming apparatus by all portions of society, including the hearing impaired, while providing significant entertainment for all players in what is clearly a highly visual format with additional sound.

### SUMMARY OF THE INVENTION

A method and apparatus for controlling levels of sound volume emitted by a gaming apparatus may include a housing, a display system, a wager entering system, a CPU comprising a timing function and/or sound sensing system and a sound output system, wherein the CPU has software and/or hardware that provides distinctly different audio levels in a process. The method may be practiced by:
a) programming associated with the timing function automatically alters the level of sound by:
   i) lowering volume according to expected times of low local noise levels and increasing volume according to expected times of high local noise levels; and
   ii) sensing an extended period of low local sound volume so that emitted game volume is lowered or kept at a relatively low volume or sensing a high level of local sound volume so that emitted game volume is maintained at a relatively high level or raised to a relatively high level.

### BRIEF DESCRIPTION OF THE FIGURES

FIG. 1 shows an individual wagering terminal according to the present technology.

FIG. 1A shows a schematic of a gaming system that may be incorporated into play of the present technology.

FIG. 1B shows a schematic of a terminal useful in the practice of the present technology.

### DETAILED DESCRIPTION OF THE INVENTION

A casino wagering apparatus has a) a housing, b) a display system, c) a wager entering system, d) a CPU with a timing function and/or sound sensing system and e) a sound output system. The CPU has software and/or hardware that provides distinctly different audio levels in response to at least one of:
a) programming associated with the timing function that alters the level of sound by lowering volume according to expected times of low local noise levels and increasing volume according to expected times of high local noise levels; and
b) sensing an extended period of low local sound volume so that emitted game volume is lowered or kept at a relatively low volume or sensing a high level of local sound volume so that emitted game volume is maintained at a relatively high level or raised to a relatively high level.

The timing function can be manually set, remotely set or statistically automatically programmed based on expected or experience levels of noise within a local, such as a casino or bar. The expected or experienced level of noise is likely associated with numbers of players within the casino. For example, the fewest number of players within a casino would likely be between the hours of 3 a.m. and 9 a.m., and the largest number of players between 6 p.m. and 1 a.m. The programming would therefore have a relatively low maximum volume emission (e.g., 5-25 or 10-40 decibels) for the morning period and relatively high minimum volume emission (e.g., 40-65 or 40-85 decibel) for the evening/night period.

Similarly, the sound sensor receives information on local sound levels and adjusts the emitted sounds from the sound output system in response to the sensed sound levels. The response preferably would not be instantaneous, or the sound levels rapid shifting with short term transitory shifts. It would be preferred if the sound levels were sampled or averaged over time periods (e.g., at least one minute, at least five minutes, at least 15 minutes or more). Before the underlying sound emission volumes were raised. Another basis for considering the terms relatively high volumes or relatively low volumes would be by considering a scholastic measurement of volume, with 0 as the lowest volume or silence and 10 indicating maximum volume or highest allowed volume. A low volume might include scholastic levels of 1-4 and the highest levels would include 6-9 scholastic levels.

The reel slot wagering apparatus may have distinctly different sound volumes are provided in quantified steps of volume levels (e.g., limited to, for example, the scholastic levels of 1, 2, 3 . . . 9, 10) or may be more analog or continuous in available ranges, with distinctly different sound volumes provided in continuous volume levels.

A method, according to the present technology, of controlling levels of sound volume emitted by a gaming apparatus having a housing, a display system, a wager entering system, a CPU comprising a timing function and/or sound sensing system and a sound output system. The CPU has software and/or hardware that provides distinctly different audio levels in a process whereby:
a) programming associated with the timing function automatically alters the level of sound by:
   i) lowering volume according to expected times of low local noise levels and increasing volume according to expected times of high local noise levels; and
   ii) sensing an extended period of low local sound volume so that emitted game volume is lowered or kept at a relatively low volume or sensing a high level of local sound volume so that emitted game volume is maintained at a relatively high level or raised to a relatively high level.
      Sound Levels—Slot machines have now integrated sound into the game play more than ever. The sounds are part of the overall experience and in some cases are absolutely essential (e.g., while playing video poker, the player is alerted via a sound to inform him that the initial dealt hand is a winner). One problem that occurs is that most designers (or the operators) set the sound level for either a single game volume or the game one level changes once/day (based on when the casino is expected to be empty since they do the work during graveyard or early morning). Thus, when there is a big crowd at the casino, the sound levels are way too low. It is an aspect of the present technology to program a complete hour by hour, day by day menu for the sound levels of the game. The operator (or manufacturer could pre-set the volume settings) would go through the menu (or approve the recommended sound levels) to set the sound level customized for particular casinos.

An alternative addition could add a decibel meter to the game (hardware) that measures the sound level in the casino. The sound level would automatically turn up or down based on the sound level in the casino (sustained sound level, not just because someone yelled or a glass broke, etc.).

It is another aspect of the play of the present invention to provide a unique format for the play of the present game. The game may be formatted as a bank of more than one individual playing station or monitor, linked with a common display area. For example, a bank of 2, 3, 4, 5, 6, and individual numbers up to 100 or more video gaming apparatuses may be associated with the play of this game. Each individual reel slot game (either a physical reel or video reel) will be able to play the underlying game. Each individual station will have the reel system (physical or virtual) and may have a monitor present to assist the player in having information on the play of the game. The monitor and the associated CPU, hardware and/or software can provide functions inclusive of game status information, wagering information, credits, entertainment elements, entertainment awards, and the like. Associated with the bank of stations can be a large screen display (e.g., CRT, reflection screen, projection screen, LED, LCD, or plasma screen for the display of a feature to a larger segment of the play of a bonus feature or an entertainment feature. For example, the play of the game may proceed as follows, with as a non-limiting example, eight or ten separate player stations being associated together. Each player plays at a distinct station or reel slot machine. When a bonus play alignment or award is attained, the player advances to the bonus play. This may be accompanied by a notice or first entertainment segment displayed on an individual monitor or display associated with the individual player. There is then a bonus play display, which may be displayed on a display easily viewable by more than the individual player, as by using a display (e.g., referred to as the public display) that is above the stations of the bank of players, viewable by the one player, each and every one of the players at the bank of stations, and by passersby and other public viewers without interfering with the ability of the player to play the game, observe the reels at the station, observe the larger public display, and the like. The bonus display might embody (in keeping with the tone of this disclosure) images of the Three Stooges, with animation, shifting illumination from one Stooge to another, still displays with numbering, and the like. An individual player, having entered the bonus segment, may view and participate in the play of the bonus feature, either on his own monitor or on the public display monitor, or both.

When a player has attained a bonus play level, that player may have to be queued with other players at that level at a similar time. This may be handled by a common CPU, data processer, hardware, software, circuitry or the like. A separate, special bonus entertainment film clip or animation lasting for moderate lengths of time, for example 1 to 30 seconds may be provided at the individual player station on an individual station monitor, with a physical slot game or video slot game.

The following types of signals could be provided for the wagering apparatus that would increase accessibility to the apparatus, possibly rising to a level of play indication that the visually impaired could independently play the device. Among the independent audio features would be the provision of independent audio signals identifying the 1) availability of the apparatus to start a new wagering game, 2) presence of bet credits, 3) amount of bet credits available, 4) number or amount of bet credits wagered or coins or token wagered, 5) revelation of particular symbols, 6) position of particular symbols, 7) size of any payout, 8) denomination of currency deposited, 9) signaling a loss, 10) signaling multiple losses or wins, and other options that are described herein or become apparent to the ordinarily skilled artisan from a review of this patent. Some of these audio signals are generic to all video wagering systems, and some would be desirable or useful for only certain types of wagering systems. For example, audio signals 1), 2), 3), 4), 7), 8), 9) and 10) would be particularly relevant to almost all video wagering systems, while signals 5), and 6) would tend to be useful only where symbols may be replaced, as with draw poker video games or reel slot games where one or more reels may be re-spun after a first result.

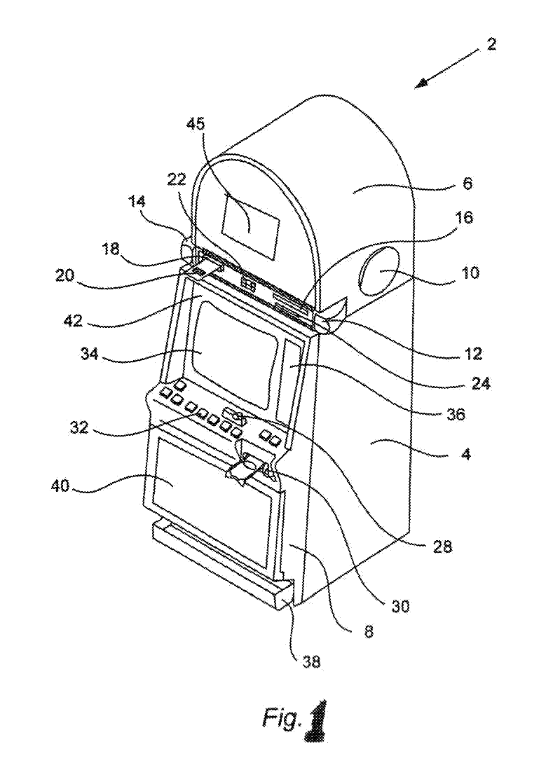

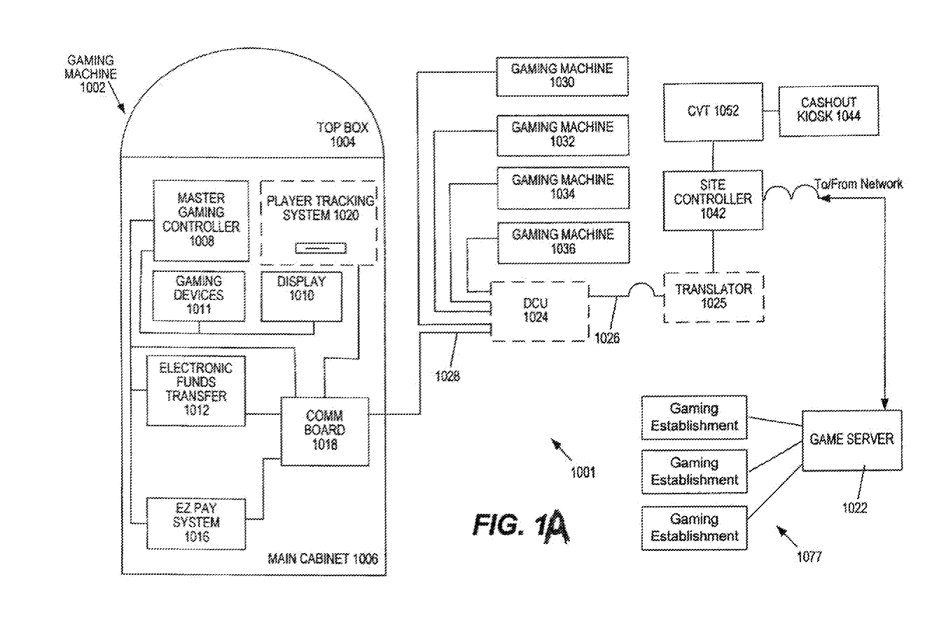

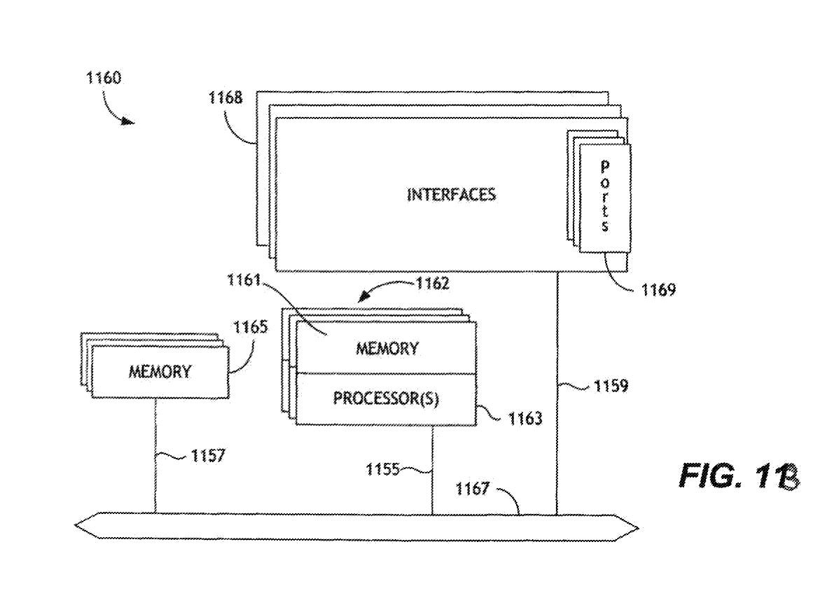

Turning next to FIG. 1, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown or in a more horizontal (table like) display unit. Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device hut then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in anon-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaining machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaining machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog tinier always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaining industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567, which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022. Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above in FIGS. 6 and 7. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system 1016 (a proprietary cashless ticketing system of the present assignee), and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

The present technology may be further defined as including a method used on the apparatus wherein there is controlling levels of sound volume emitted by a gaming apparatus including a housing, a display system, a wager entering system, a CPU comprising a timing function and/or sound sensing system and a sound output system. The CPU (computer processing unit) has software and/or hardware that provides distinctly different audio levels in a process. These distinctly different audio levels may range from low audible levels (e.g., 10-20 decibels) through midlevel sound ranges >20-50 decibels) up to relatively high sound levels e.g., >50 to 100 decibels). These ranges define relatively low, moderate and relatively high ranges of sound levels, with both the relatively low levels and relatively high levels being expandable into the moderate range (e.g., eliminating the moderate range and having relatively low go from about 10<50 decibels and having relatively high sound levels extend from >50 to 100 decibels or more). Control of the sound levels may be practiced by
a) programming associated with the timing function automatically alters the level of sound by:
   i) lowering volume according to expected times of low local noise levels and increasing volume according to expected times of high local noise levels; and
   ii) sensing an extended period of low local sound volume so that emitted game volume is lowered or kept at a relatively low volume or sensing a high level of local sound volume so that emitted game volume is maintained at a relatively high level or raised to a relatively high level.

The method may be practiced wherein controlling sound levels is performed by lowering volume according to expected times of low local noise levels and increasing volume according to expected times of high local noise levels. The method may be practiced wherein controlling sound levels is performed by raising volume according to expected times of low local noise levels and lowering volume according to expected times of high local noise levels. The method may be practiced wherein controlling sound levels is performed by sensing an extended period of low local sound volume so that emitted game volume is lowered or kept at a relatively low volume or sensing a high level of local sound volume so that emitted game volume is maintained at a relatively high level or raised to a relatively high level. The method may be practiced wherein controlling sound levels is performed by sensing an extended period of low local sound volume so that emitted game volume is raised sensing a high level of local sound volume so that emitted game volume is lowered to a relatively low level.

What is claimed:

1. A casino wagering apparatus comprising a housing, a display system, a wager entering system, a computer processing unit comprising a timing function and/or sound sensing system, and a sound output system, wherein the computer processing unit has software and/or hardware that provides distinctly different audio levels in response to at least one of:
a) programming associated with the timing function that alters the level of sound by lowering volume according to expected times of low local noise levels and increasing volume according to expected times of high local noise levels; and
b) sensing an extended period of low local sound volume so that emitted game volume is lowered or kept at a relatively low volume or sensing a high level of local sound volume so that emitted game volume is maintained at a relatively high level or raised to a relatively high level.

2. The wagering apparatus of claim 1 wherein the computer processing unit is configured, upon receipt of sound level signal data either through a local sound sensor or according to programmed expected times of relatively low or relatively high ambient noise levels, to adjust emitted sound levels during game play downward in relatively low ambient background sound levels and upward in relatively high ambient noise levels.

3. The wagering apparatus of claim 1 wherein while the gaming device has not been played for a designated period of time, the sound level for emissions during actual game play mode is adjusted to be respectively higher for low ambient noise levels and lower for relatively high ambient noise levels.

4. The reel slot wagering apparatus of claim 1 wherein distinctly different sound volumes are provided upon direction by the computer processing unit in quantified steps of volume levels and at least some steps differ from other volume levels by at least 5 decibels.

5. The reel slot wagering apparatus of claim 1 wherein distinctly different sound volumes are provided upon direction by the computer processing unit in continuous volume levels.

6. A method of controlling levels of sound volume emitted by a gaming apparatus comprising a housing, a display system, a wager entering system, a CPU comprising a timing function and/or sound sensing system and a sound output system, wherein the CPU has software and/or hardware that provides distinctly different audio levels in a process whereby:
b) programming associated with the timing function automatically alters the level of sound by:
i) lowering volume according to expected times of low local noise levels and increasing volume according to expected times of high local noise levels; and
ii) sensing an extended period of low local sound volume so that emitted game volume is lowered or kept at a relatively low volume or sensing a high level of local sound volume so that emitted game volume is maintained at a relatively high level or raised to a relatively high level.

7. The method of claim 6 wherein controlling sound levels is performed by lowering volume according to expected times of low local noise levels and increasing volume according to expected times of high local noise levels.

8. The method of claim 6 wherein controlling sound levels is performed by raising volume according to expected times of low local noise levels and lowering volume according to expected times of high local noise levels.

9. The method of claim 6 wherein controlling sound levels is performed by sensing an extended period of low local sound volume so that emitted game volume is lowered or kept at a relatively low volume or sensing a high level of local sound volume so that emitted game volume is maintained at a relatively high level or raised to a relatively high level.

10. The method of claim 6 wherein controlling sound levels is performed by sensing an extended period of low local sound volume so that emitted game volume is raised sensing a high level of local sound volume so that emitted game volume is lowered to a relatively low level.
